(19) United States
(12) Patent Application Publication
(10) Pub. No.: US 2023/0322108 A1
(43) Pub. Date: Oct. 12, 2023

(54) MOVABLE RECEIVER COIL FOR IMPROVED WIRELESS COUPLING & CHARGING

(71) Applicant: Toyota Motor Engineering & Manufacturing North America, Inc., Plano, TX (US)

(72) Inventor: BRIAN WOODS, Brighton, MI (US)

(21) Appl. No.: 17/716,931

(22) Filed: Apr. 8, 2022

(51) Int. Cl. B60L 53/39; H02J 50/10; H02J 50/90; B60L 53/12

(52) U.S. Cl. CPC B60L 53/39; B60L 53/12; H02J 50/90; H02J 50/10

(57) ABSTRACT

The external vehicle charging system includes an inductive coil configured to provide an alternating magnetic field to a movable receiver coil of a vehicle, an adjustable arm coupled to the movable receiver coil, a sensor configured to detect a position of the movable receiver coil of the vehicle, and a processor connected to the inductive coil, the adjustable arm, and the sensor. The processor is configured to determine a charging request, and, in response to the charging request, activate the adjustable arm so that the distance between the inductive coil and the movable receiver is reduced.

### BACKGROUND

### 1. Field

This specification relates to a system and a method for inductively and/or wirelessly charging a vehicle.

### 2. Description of the Related Art

Vehicles, such as electric vehicles (EV) and plug-in hybrid vehicles (PHV) may charge their batteries via inductive charging. Inductive charging, also known as wireless charging, uses an electromagnetic field to transfer electrical energy between a source, such as a charging station, and a device, such as an EV or PHV vehicle, that stores and/or uses the electrical charge. An inductive coil at a power source, such as a charging station, creates an alternating electromagnetic field which is transmitted to an inductive coil (or “inductive loop”) at the vehicle that converts the power from the electromagnetic field into an electric current to charge a battery and/or run the vehicle. The inductive coil of the charging station is often in a fixed position and the vehicle is placed or positioned on or near the charging station. The corresponding inductive loop of the vehicle, however, may be too far away from the inductive coil of the charging station which results in a decrease in the efficiency of the transfer of electrical energy. That is, when the corresponding loop is at a great distance from the charging station, electrical energy is lost in the transfer of the electrical energy to the corresponding inductive loop.

Accordingly, there is a need for a system and a method to improve the efficiency of wirelessly charging the vehicle.

### SUMMARY

In general, one aspect of the subject matter described in this specification is embodied in an external vehicle charging system. The external vehicle charging system includes an inductive coil configured to provide an alternating magnetic field to a movable receiver coil of a vehicle, an adjustable arm coupled to the movable receiver coil, a sensor configured to detect a position of the movable receiver coil of the vehicle, and a processor connected to the inductive coil, the adjustable arm, and the sensor. The processor is configured to determine a charging request, and, in response to the charging request, activate the adjustable arm so that the distance between the inductive coil and the movable receiver is reduced.

In another aspect, the subject matter is embodied in a receiving assembly of an external vehicle charging system. The receiving assembly includes a movable receiver coil disposed on a bottom surface of a vehicle, and an adjustable arm coupled to the movable receiver coil. The adjustable arm is configured to descend the movable receiver toward an inductive coil configured to provide an alternating magnetic field to the movable receiver coil.

In another aspect, the subject matter is embodied in a method for wirelessly charging a vehicle. The method includes determining a charging request, and, in response to the charging request, activating an adjustable arm coupled to a movable receiver coil of a vehicle so that a distance between the movable receiver coil and an inductive coil configured to provide an alternating magnetic field to the movable receiver coil is reduced.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a schematic of an example external vehicle charging system to charge a vehicle according to an aspect of the invention.

FIG. 2 shows an example external vehicle charging system of FIG. 1 integrated into a charging station charging a vehicle according to an aspect of the invention.

FIG. 3 shows an example receiving assembly of the vehicle of FIG. 2 to align the vehicle with the charging pad of the charging station according to an aspect of the invention.

FIG. 4 is an example protective housing of the receiving assembly of FIG. 3 to protect a movable receiving coil of the receiving assembly according to an aspect of the invention.

FIG. 5 is a flow diagram of an example process for providing electrical energy to the receiving assembly of the vehicle according to an aspect of the invention.

### DETAILED DESCRIPTION

Disclosed herein are systems, devices and methods for wirelessly charging a vehicle. Particular embodiments of the subject matter described in this specification may be implemented to realize one or more of the following advantages.

An external vehicle charging system transmits a wireless charging signal from a charging station to charge one or more power storage devices, such as a battery, and/or provide power to move the vehicle. The external vehicle charging system has one or more inductive coils that transmit the wireless charging signal by generating a magnetic field using an alternating current (AC).

The external vehicle charging system includes a wireless charging pad which houses the inductive coil, and the vehicle includes a movable receiver coil (e.g., a magnetic field coupler, the inductive loop) configured to interact with the wireless charging pad. The movable coil is movably coupled to the vehicle such that the movable coil is configured to descend from the bottom of the vehicle to reduce the distance between the charging pad and improve the efficiency of wireless power transfer between the receiver coil of the vehicle and the charging source. For instance, the wireless energy transfer between the charging pad and the vehicle is improved by providing the vehicle with a movable receiver coil so that the vehicle's charge receiver can become closer to the ground based charge transmitter.

The wireless charging pad may be located, for example, on the floor of a garage. The charging pad is connected to a data store capable of wirelessly retrieving data pertaining to what electronic devices are located on the charging pad. The data store can record the kind of object on the device, the state of charge of the device, the times in which the electronic devices are normally used (e.g., an electronic device schedule), and other pertinent information.

The movable receiver coil is a deployable contact for charging a system where the distance between the wireless charging pad and the wireless receiver coil is too far even for wireless charging due to the nature of the device (e.g., a lifted truck). The movable receiver coil improves the speed and efficiency of wireless power transfer, including charging via coupled magnetic resonance (capable of charging over longer distances). For instance, the distance between the vehicle and the charging pad is limiting, so magnetic resonance is beneficial in that the energy can be focused and thus can travel a greater distance. The method and systems herein for lowering a receiver from the vehicle thus result in a greater transfer of energy.

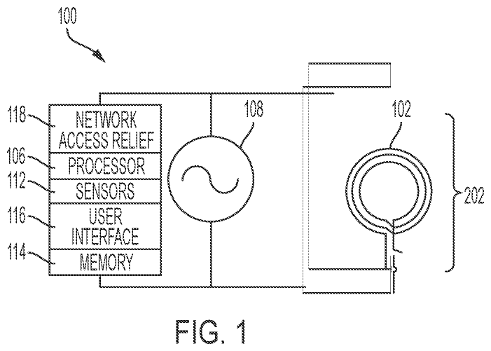

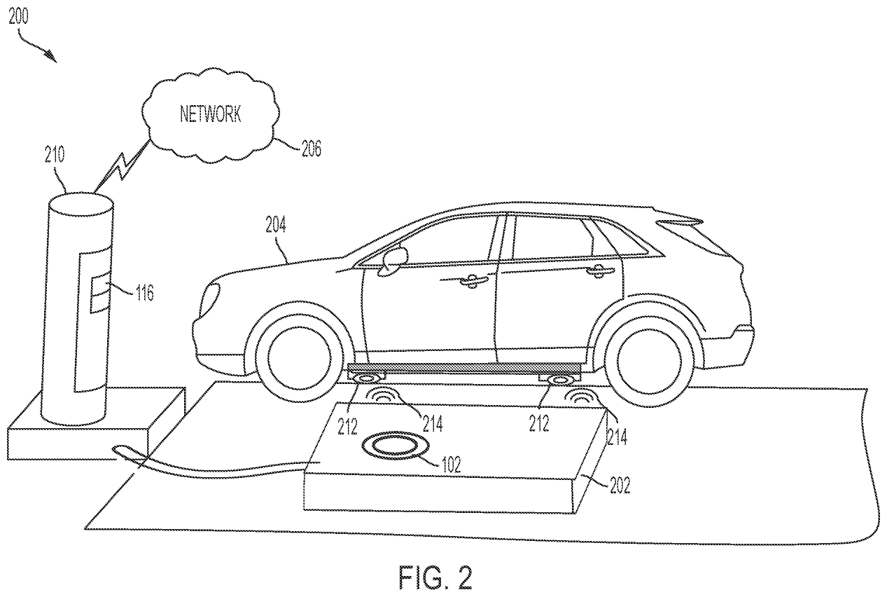

FIG. 1 is a schematic of an example external vehicle charging system 100. The external vehicle charging system 100 (“charging system”) is included within, connected to or a part of a charging station 210 that has a charging pad 202, as shown in FIG. 2, for example. The external vehicle charging system 100 transmits a wireless charging signal, such as an alternating magnetic field, that when received by or is within a proximity of one or more inductive loops of a vehicle 204 causes the inductive loop to generate electrical energy to be stored in the one or more batteries 216 of the vehicle 204 and/or used by the vehicle 204 to move.

The external vehicle charging system 100 includes a processor 106, a power source 108, and a memory 114. The external vehicle charging system 100 includes one or more inductive coils 102 of the charging pad 202. The charging system 100 may include a user interface 116, a network access device 118 and/or one or more sensors 112.

The charging system 100 has one or more computers, such as a processor 106. The processor 106 may be a controller, a microprocessor or other control device that executes or performs operations stored on or in the memory 114. The processor 106 may be remote or local to a charging station. The processor 106 may be configured to control the various components including the network access device 118, the one or more sensors 112, and the power source 108 to detect the vehicle 204 on the charging pad 202 of the charging station 210, activate or deactivate power to the one or more inductive coils 102 to charge the vehicle 204, and activate or deactivate a movable receiver coil 212.

The charging system 100 includes a memory 114. The memory 114 may be coupled to the one or more processors 106. The memory 114 may store instructions to execute on the one or more processors 106 and may include one or more of a RAM (Random Access Memory) or other volatile or non-volatile memory. The memory 114 may be a non-transitory memory or a data storage device, such as a hard disk drive, a solid-state disk drive, a hybrid disk drive, or other appropriate data storage, and may further store machine-readable instructions, which may be loaded and executed by the one or more processors 106.

The charging system 100 includes a power source 108. The power source 108 may provide an alternating current (AC) to emit through the one or more inductive coils 102. The alternating current through the one or more inductive coils 102 may create or generate a magnetic field that is transmitted or emanated by the one or more inductive coils 102. When a movable receiver coil 212 of the vehicle 204 is within a threshold distance of the one or more inductive coils 102, the magnetic field may generate current within the one or more inductive loops. The current is converted into direct current (DC) which charges or runs the vehicle 204.

The charging system 100 may have one or more sensors 112. The one or more sensors 112 may include a charging sensor, a proximity sensor, an alignment sensor and/or a camera.

The one or more sensors 112 may include a charging sensor for the inductive coil 102. The charging sensor 112 may measure an efficiency factor for the inductive coil 102. For example, the charging sensor 112 may detect that the movable receiver coil 212 of the vehicle 204 is generating an electrical charge from the magnetic field of the inductive coil 102 at approximately 33% efficiency, whereas if the distance between the inductive coil 102 and the movable receiver coil 212 was reduced, the generation of the electrical charge from the magnetic field of the inductive coil 102 could be at approximately 80% efficiency. Thus, the external vehicle charging system 100 may determine that the inductive coil 102 is more efficient at a certain distance.

The one or more sensors 112 may include a proximity sensor. The proximity sensor may measure or detect a distance from the charging pad 202 to the vehicle 204. The charging system 100 may use the measured or detected distance to activate when the vehicle 204 is within a threshold distance of the charging station 210.

The one or more sensors 112 may include an alignment sensor. The alignment sensor may be used to align the inductive coils 102 with the movable receiver coil 212 of the vehicle 204. The alignment sensor may be a target sensor that signals when the target sensor is aligned with an optical sensor on the vehicle 204. When the sensors are aligned, the efficiency of transfer and generation of electrical energy for storage in the vehicle 204 is at its maximum or peak, e.g., approximately 80%-90% efficiency. The alignment sensor may provide an indication of a direction to move the vehicle 204 and/or navigate the vehicle 204 to align the alignment sensor with the target sensor.

The user interface 116 may be positioned on and/or connected to the charging station 210. The user interface 116 may provide an interface for input and/or output. The user interface 116 may have user elements. The user interface 116 may receive user input such as the selection of user elements to obtain one or more configuration settings that position and/or activate the inductive coil 102. The output may include notifications and/or alerts indicating the initialization or use of the charging system 100 and/or the positioning of the inductive coil 102 relative to the movable receiver coil 212 of the vehicle 204.

The charging system 100 may include a network access device 118. The network access device 118 may include a communication port or channel, such as one or more of a Wi-Fi unit, a Bluetooth® unit, a radio frequency identification (RFID) tag or reader, or a cellular network unit for accessing a cellular network (such as 3G or 4G). The network access device 118 may transmit data to and receive data from devices and systems not directly connected to the charging station 210, such as an interconnected network of systems 200 as shown in FIG. 2.

FIG. 2 shows an interconnected network of systems 200 that includes the charging station 210 with the charging system 100 and a vehicle 204. The interconnected network of systems (“network system”) 200 may include a vehicle 204, the charging station 210 with the charging pad 202, and a network 206.

The charging station 210 may have a charging pad 202. The charging pad 202 may be positioned such that the vehicle 204 is positioned above the charging pad 202 to receive the electrical charge from the charging station 210. The charging station 210 may provide power to the charging pad 202 to wirelessly charge the vehicle 204. In various embodiments, the magnetic field may extend to one large inductive coil 102. For instance, one large inductive coil may maximize the current transfer as amount of current that can be transferred may be proportion with the size of the copper coil. In various embodiments, the magnetic field may extend to one or more inductive loops of the vehicle and generate current within the one or more inductive loops.

The charging system 100 may be embedded within or retrofitted to the charging station 210. The one or more inductive coils 102 that are within the charging pad 202 may wirelessly charge the vehicle 204 from underneath the vehicle 204. The inductive coils 102 may provide an electromagnetic field 214 which is transmitted to the movable receiver coil 212 of the vehicle 204. The movable receiver coil 212 converts the electromagnetic field into an electric current that charges a battery 216 of the vehicle 204.

A vehicle 204 is a conveyance capable of transporting a person, an object, or a permanently or temporarily affixed apparatus. A vehicle 204 may be a self-propelled wheeled conveyance, such as a car, a sports utility vehicle, a truck, a bus, a van or other motor or battery driven vehicle. For example, the vehicle 204 may be an electric vehicle (EV), a hybrid vehicle, a plug-in hybrid vehicle (PHV) or any other type of vehicle that includes one or more batteries, motors and/or generators. Other examples of vehicles include bicycles, trains, planes, or boats, and any other form of conveyance that is capable of transportation. The vehicle 204 may be semi-autonomous or autonomous. That is, the vehicle 204 may be self-maneuvering and navigate without human input. An autonomous vehicle may use one or more sensors and/or navigation unit to drive autonomously.

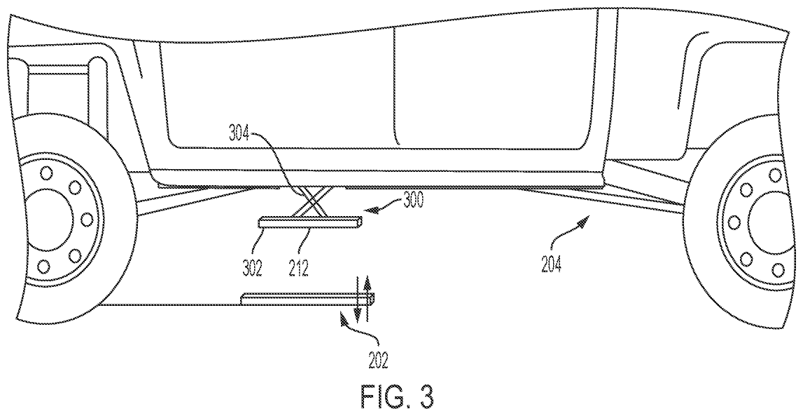

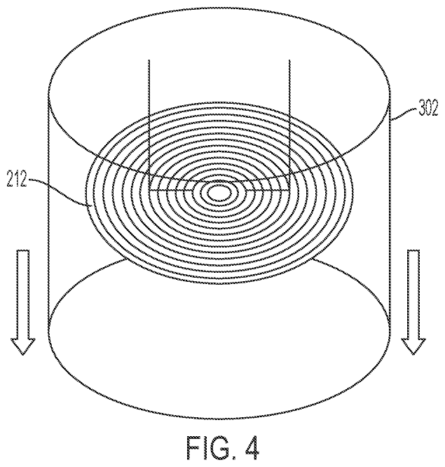

Referring now to FIGS. 3 and 4, the charging system 100 includes a receiving assembly 300. The receiving assembly 300 includes the movable receiver coil 212. The movable receiver coil 212 may be disposed in a protective housing 302. The protective housing 302 may be a shield, or cover, casing the movable receiver coil 212 to prevent rocks and other road debris from damaging the movable receiver coil 212 while the vehicle is in use. The protective housing 302 may include a mechanism configured to open (e.g., move, slide, rotate, etc.) the protective housing 302, to expose the movable receiver coil 212. In various embodiments, the protective housing 302 may have an open bottom end such that the movable receiver coil 212 is configured to descend from and out of the open bottom end of the protective housing 302. In various embodiments, the electromagnetic field 214 can be received by the movable receiver coil 212 through a surface of the protective housing 302.

The receiving assembly 300 may include an adjustable arm 304. The adjustable arm 304 may be configured to move (adjust, descend, ascend, etc.) the movable receiver coil 212. The adjustable arm 304 may be a lifting jack, a scissor lift, telescoping platform, etc. In various embodiments, the adjustable arm 304 may be coupled to a servomotor configured to lower and raise the movable receiver coil 212 and/or the protective housing 302 containing the movable receiver coil 212. In various embodiments, the adjustable arm 304 may be hydraulic or pneumatic.

In various embodiments, the charging pad 202 may include a moving mechanism. The moving mechanism may be configured to move (adjust, descend, ascend, etc.) the charging pad 202. The moving mechanism may be similar to the adjustable arm 304 described here. As such, the moving mechanism coupled to the charging pad 202 lifts the inductive coil 102 toward the movable receiving coil 212. In various embodiments, the vehicle charging system 100 includes both the adjustable arm 304 of the receiving assembly 300 and a moving mechanism coupled to the charging pad 202 such that both the charging pad 202 and the movable receiver coil 212 move toward each other to increase charging efficiency by reducing the distance between. The charging pad 202 may be a bidirectional charging pad capable of taking energy from and giving energy to the electric vehicle, and/or any other electronic device connected to the charging pad. For instance, the charging system 100 may be compatible with all mobility devices (e.g., a tractor, electric tools, bikes, other equipment, etc.).

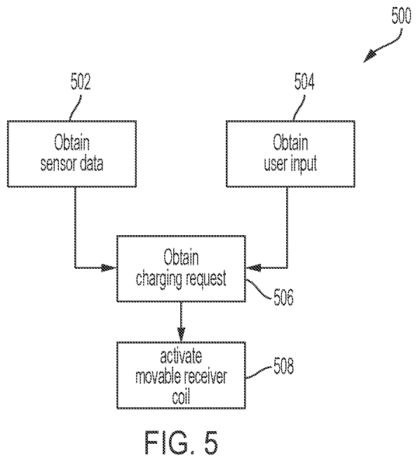

FIG. 5 is a flow diagram of a process 500 for wirelessly charging the vehicle 204. One or more computers or one or more data processing apparatuses, for example, the one or more processors 106 of the external vehicle charging system 100 of FIG. 1, appropriately programmed, may implement the process 500.

The external vehicle charging system (“charging system”) 100 may obtain sensor data from one or more sensors 112 (502). The sensor data may include a distance between a vehicle and the charging system 100. Particularly, the sensor data may include a distance between a charging pad 202 of the charging system 100 and a movable receiver coil 212 disposed under the vehicle. The sensor data may measure or detect the distance using a proximity sensor. The sensor data may include a location of the vehicle relative to the charging system 100. The sensor data may include a measurement of an efficiency factor of the movable receiver coil 212 of the vehicle that is generating electrical energy from a transmitted wireless charging signal.

The charging system 100 may receive or obtain user input, e.g., from the user interface 116 (504). The user input may be a selection of a user element associated with the movable receiver coil 212. The user input may include one or more configuration settings that activate or deactivate the moveable receiver coil 212.

Based on the sensor data obtained at 502 or the user input obtained at 504, for instance, the charging system 100 may obtain a charging request that initiates the charging system 100 (506). The external vehicle charging system 100 may receive the charging request when a user activates the charging system 100, e.g., when the charging station 210 is turned on or a user activates the charging system 100 from the user interface 116 to charge the vehicle 204. The charging system 100 may receive the charging request from the one or more sensors 112. For example, when an EV and/or PHV vehicle 204 is within a threshold distance of the charging station 210, a proximity sensor and/or an alignment sensor may detect the vehicle 204 and initialize the charging system 100 based on the charging request. Once the charging system 100 is initiated, the moveable receiver coil 212 may be activated such that the movable receiver coil 212 descends from the vehicle toward the charging pad 202 (508). In another example, upon initiating the charging system 100, the charging pad 202 may be activated and move toward the movable receiver coil 212.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An external vehicle charging system, comprising:
an inductive coil configured to provide an alternating magnetic field to a movable receiver coil of a vehicle;
an adjustable arm coupled to the movable receiver coil;
a sensor configured to detect a position of the movable receiver coil of the vehicle; and
a processor connected to the inductive coil, the adjustable arm, and the sensor, the processor being configured to:
determine a charging request, and
in response to the charging request, activate the adjustable arm so that the distance between the inductive coil and the movable receiver is reduced.

2. The external vehicle charging system of claim 1, wherein the charging request is based on the detected position of the movable receiver coil such that the position indicates a distance between the inductive coil and the movable receiver coil, the charging request initiated in response to the distance being greater than a threshold distance.

3. The external vehicle charging system of claim 1, wherein the charging request is based on a user input.

4. The external vehicle charging system of claim 1, wherein the adjustable arm is at least one of a lifting jack, a scissor lift, and a telescoping platform.

5. The external vehicle charging system of claim 1, wherein the adjustable arm is coupled to a servomotor configured to lower and raise the movable receiver coil.

6. The external vehicle charging system of claim 1, wherein the adjustable arm is at least one of a hydraulic arm and a pneumatic arm.

7. The external vehicle charging system of claim 1, wherein the movable receiver coil is housed in a protective housing.

8. The external vehicle charging system of claim 1, further comprising a charging pad, wherein the inductive coil is disposed within the charging pad.

9. The external vehicle charging system of claim 1, wherein the inductive coil is configured to move.

10. The external vehicle charging system of claim 9, wherein the processor is further configured to, in response to the charging request, activate the inductive coil to move so that the distance between the inductive coil and the movable receiver is reduced.

11. A receiving assembly of an external vehicle charging system, the receiving assembly comprising:
a movable receiver coil disposed on a bottom surface of a vehicle; and
an adjustable arm coupled to the movable receiver coil, the adjustable arm configured to descend the movable receiver toward an inductive coil configured to provide an alternating magnetic field to the movable receiver coil.

12. The receiving assembly of claim 11, wherein the receiving assembly is coupled to a processor, the processor configured to:
determine a charging request, and
in response to the charging request, activate the adjustable arm so that the distance between the inductive coil and the movable receiver is reduced.

13. The receiving assembly of claim 11, wherein the adjustable arm is configured to position the movable receiver coil within a threshold distance of the inductive coil.

14. The receiving assembly of claim 13, wherein to the adjustable arm is configured to move the movable receiver coil in at least one of a vertical direction perpendicular to a plane of a charging pad located below the vehicle, the charging pad configured to house the inductive coil.

15. The receiving assembly of claim 11, further comprising a protective housing configured to house the movable receiver coil.

16. A method for wirelessly charging a vehicle, comprising:
determining a charging request, and
in response to the charging request, activating an adjustable arm coupled to a movable receiver coil of a vehicle so that a distance between the movable receiver coil and an inductive coil configured to provide an alternating magnetic field to the movable receiver coil is reduced.

17. The method of claim 16, wherein the charging request is based on a detected position of the movable receiver coil via a sensor configured to detect the position of the movable receiver coil such that the position indicates the distance between the inductive coil and the movable receiver coil.

18. The method of claim 17, further comprising initiating the charging request in response to the distance being greater than a threshold distance.

19. The method of claim 16, wherein the charging request is based on a user input.

20. The method of claim 16, further comprising, in response to the charging request, activating the inductive coil to move so that the distance between the inductive coil and the movable receiver is reduced.
